(19) United States
(12) Patent Application Publication
(10) Pub. No.: US 2023/0079998 A1
(43) Pub. Date: Mar. 16, 2023

(54) Pet Nail Machine

(71) Applicant: Guangzhou Langzhu Network Technology Co., Ltd., Shiling (CN)

(72) Inventor: Haohan Zeng, Tatou (CN)

(21) Appl. No.: 17/477,507

(22) Filed: Sep. 16, 2021

(51) Int. Cl. A01K 13/00; A45D 29/05

(52) U.S. Cl. CPC A01K 13/00; A45D 29/05

(57) ABSTRACT

The invention discloses a pet nail machine, comprising: an operating rod and a nail machine shell; the operating rod penetrates from inside of the nail machine shell, and one end of the operating rod outside the nail machine shell is connected Grinding wheel, illuminating LED light, magnifying glass and filter box. The operating rod inside the shell of the nail machine is connected with a turbine, a filter, a motor and a battery, and the control board is fixed above the battery; The surface is equipped with buttons and operating indicators, and a USB charging interface is led out at the rear of the nail machine shell; the control board and the lighting LED light, the motor, the battery, the buttons and the operating indicator Electrically connected, the motor is mechanically connected to the grinding wheel and the turbo, and the USB charging port is electrically connected to the battery.

### TECHNICAL FIELD

The invention relates to a nail machine, in particular to the technical field of a pet nail machine.

### BACKGROUND

Nowadays, cats, dogs, birds and other animal pets are an indispensable member of family life. Pet care equipment is emerging in endlessly, and the pet commodity market is quietly formed. The pet nail machine can polish the sharp parts of pet nails without changing the function of pet nails to prevent animal claws from hurting people or damaging furniture, while maintaining the beauty of pet nails. Existing pet nail art devices are usually equipped with LED lights, but because pet nails are generally very small and there are blood vessels inside the nails, even under the action of light, the user will not be able to operate the pet nail machine. Misuse of cleaning will cause damage to the blood vessels or body of the pet's nails. In addition, the pet nail machine will produce nail debris and peculiar smell during the process of polishing the pet's nails, which will be caused by the front grinding wheel. Rotational inertia makes it fly around and fall and it is difficult to clean up, and the peculiar smell generated by heating the nails is very unpleasant. The user will continue to inhale such nail dust and peculiar smell during use, which is very harmful to human health.

### SUMMARY

The purpose of the present invention is to provide a pet nail machine that confirms the nail machine position through a magnifying glass, and also sucks the nail scraps into the filter box through a turbine for collection, and absorbs the odor generated by the nail machine through the filter cotton to reduce air pollution And affect human health.

In order to achieve the above objective, the present invention provides the following technical solutions: A pet nail machine, comprising: an operating rod and a nail machine shell; One end of the operating rod outside the shell of the nail machine is connected with a grinding wheel, a lighting LED light, a magnifying glass and a filter box, and the operating rod inside the shell of the nail machine is connected with a turbine, a filter, a filter cotton, a motor and a battery, A control main board is fixed above the battery; a button and a running indicator are installed on the surface of the nail machine shell, and a USB charging interface is led out at the rear of the nail machine shell; the control main board and the lighting LED light, The motor, the battery, the button, and the running indicator are electrically connected, the motor is mechanically connected to the grinding wheel and the turbo, and the USB charging interface is electrically connected to the battery.

As a preferred technical solution of the present invention, the operating rod is used to connect various components and is divided into two parts, an inner part and an outer part, by the housing.

As a preferred technical solution of the present invention, the grinding wheel is used to polish the nails of pets, to smooth the damaged parts, or to polish the sharp parts of pet nails to prevent people from scratching.

As a preferred technical solution of the present invention, the illuminating LED lamp is used to illuminate the nails being polished when the user polishes the nails of the pet, so as to prevent the blood vessels and surrounding skin inside the pet's nails from being unclearly damaged.

As a preferred technical solution of the present invention, the magnifying glass is used to magnify the nail under the grinding wheel, so that the blood vessels around the pet nail can be observed more clearly, so that the direction and position of the nail can be adjusted reasonably.

As a preferred technical solution of the present invention, the filter box is used to store nail scraps generated during the nail grinding process.

As a preferred technical solution of the present invention, the filter is used to prevent the nail scraps generated by the nail machine from being sucked into the inside of the shell of the nail machine, causing system failure.

As a preferred technical solution of the present invention, the filter cotton is used to absorb the peculiar smell generated when the nail machine is used, and reduce the pollution to the surrounding air.

As a preferred technical solution of the present invention, the turbine is used to suck away nail scraps and peculiar smells generated when a user performs a manicure on a pet, and suck the nail scraps into the filter box.

As a preferred technical solution of the present invention, the motor is used to drive the turbine and the grinding wheel to work when the pet nail machine is turned on.

As a preferred technical solution of the present invention, the battery is used to provide electrical energy to the motor and the main board.

As a preferred technical solution of the present invention, the control board is used to receive a user's control instruction, and complete the corresponding function according to the control instruction; the user's control instruction is generated by the button, and the button can generate boot, Various control commands such as shutdown and gear switching. The user presses the button for 3 seconds to generate the on or off control command. In the power-on state, short press once to switch one gear. The gears are from low, medium, and high. Mode switching is used to control the running speed of the grinding wheel; the control command is indicated by the running indicator light to indicate the current operating status of the system. The running indicator light is distinguished by RGB three-color lights. The middle and high grades are represented by different colors.

As a preferred technical solution of the present invention, the USB charging interface is used to charge the battery, is electrically connected to the battery, and when the operation instruction prompts that charging is required, the power source is connected to the USB The charging interface can complete the charging of the pet nail machine.

As a preferred technical solution of the present invention, the housing is used to protect the internal circuit of the pet nail machine and provide the external structure of the button, the running indicator, and the USB charging interface.

Compared with the previous technology, the beneficial effect of the present invention is:

The pet nail machine of the present invention adds a magnifying glass on the premise that there is an LED lamp in the prior art. The magnifying glass can be used to clearly observe the distribution of the fur around the pet nail and the internal blood vessel, and the LED lamp lighting is further improved. Improve the safety of pets when using the nail machine.

In addition, the turbine in the pet nail machine of the present invention has a fast vacuum function, which easily solves the unsanitary problems of the user inhaling nail scraps generated by the nail when using the pet nail machine, and quickly sucks away the polishing process. The peculiar smell produced in the nail polisher reduces the discomfort of the user during the nail polishing process.

### DESCRIPTION OF DRAWINGS

The present invention will be further described below in conjunction with the accompanying drawings and embodiments. In the accompanying drawings:

FIG. 1 is a structural block diagram of a pet nail sharpener of the present invention.

### DETAILED DESCRIPTION

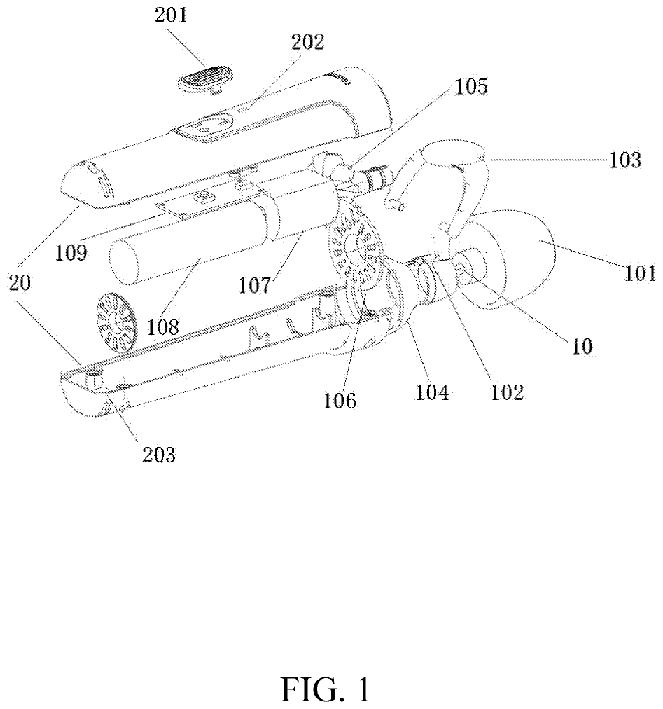

As shown in FIG. 1, a pet nail machine of this embodiment includes: an operating rod 10 and a nail polisher housing 20; the operating rod 10 penetrates from the inside of the nail machine housing 20, One end of the operating rod 10 outside the nail machine housing 20 is connected to the grinding wheel 101, the lighting LED lamp 102, the magnifying glass 103 and the filter box 104, and the operating rod 10 inside the nail machine housing 20 is connected to the turbine 105 and the filter box. Sheet 106. A filter cotton, a motor 107 and a battery 108 are also placed in front of the filter sheet. A control board 109 is fixed above the battery 108; a button 201 and a running indicator light 202 are installed on the surface of the nail machine housing 20, A USB charging interface 203 is led out at the tail of the nail machine housing 20; the control board 109 and the lighting LED light 102, the motor 107, the battery 108, the button 201 and the running indicator light 202 The motor 107 is electrically connected to the grinding wheel 101 and the turbine 105, and the USB charging port 203 is electrically connected to the battery 108.

Specifically, when the user uses the pet nail machine, long press the button 201 on the nail machine housing 20 for more than 3 seconds to generate a power-on signal, Control the main board inside the shell 20 of the nail machine, the main board 109 receives the start signal, controls the motor 107 to turn on, controls the running indicator light 202 to be “green”, controls the lighting LED light 102 to turn on, and controls the motor 107 to drive the grinding wheel 101 and the grinding wheel 101 The turbine 105 works, and the grinding wheel 101 operates at a low speed.

Specifically, when the user uses the pet nail machine, the lighting LED light 102 that is turned on provides good light, illuminates the position of the nail, and prevents accidental damage to the skin and blood vessels inside the nail during the machine process.

Specifically, the pet nail machine will produce burnt smell and nail scraps during use, and the suction generated by the turbine 105 will suck the burnt smell and nail scraps into the filter box 104 together. There is a filter sheet and filter cotton in front of the turbine 105 to prevent nail scraps generated during the nail grinding process from being sucked into the inside of the nail machine housing 20.

Specifically, during the use of the petnail machine, the user can briefly press the button 201 to send the control command to the control main board 109, and the control main board 109 calculates the time when the control command is generated. Whether the length exceeds 3 seconds to determine whether a short-press event has occurred. If it is determined that a short-press event has occurred, the control board 109 starts to adjust the current of the motor 107 to switch the gear of the motor 107. The gears are cyclically switched between low-speed, medium-speed, and high-speed. At the same time, the control main board 109 controls the running indicator light 202 to light up different colors during the gear-switching process to display the gear at this time, such as “blue “Color” represents medium speed, and “pink” represents high speed.

Specifically, when the pet nail machine is At low voltage, the control main board 109 controls the operation indicator to flash “red”, indicating that charging is required; the user connects to the power supply through the USB charging interface 203 The pet nail machine is charged; during the charging process, the control main board 109 controls the running indicator light 202 to keep on “red” to indicate that it is charging; when the battery is fully charged, the control main board 109 turns off the Run indicator light 202 to indicate the end of charging.

I claim:

1. A pet nail machine, comprising: an operating rod and a manicure machine housing; the operating rod penetrates from the inside of the manicure machine housing, and one end of the operating rod outside the manicure machine housing is connected with a grinding wheel, Illuminating LED light, magnifying glass and filter box, the operating rod inside the shell of the nail machine is connected with a turbine, a filter, a motor and a battery, and the control board is fixed above the battery; installed on the surface of the shell of the nail machine There are buttons and a running indicator, and a USB charging interface is led out at the rear of the nail machine shell; the control board is electrically connected to the lighting LED light, the motor, the battery, the button and the running indicator Connected, the motor is mechanically connected with the grinding wheel and the turbo, and the USB charging port is electrically connected with the battery.

2. The pet nail machine according to claim 1, wherein the operating rod is used to connect various components, and is divided into two parts, an inner part and an outer part, by the housing.

3. The pet nail machine according to claim 1, characterized in that the grinding wheel is used to polish the pet's nails, to smooth the damaged parts, or to polish the sharp parts of the pet's nails to prevent people from scratching.

4. The pet nail machine according to claim 1, characterized in that: the illuminating LED lamp is used to illuminate the nails being polished when the user polishes the nails of the pets to prevent the pet nails from being damaged by mistake, Blood vessels and surrounding skin.

5. The pet nail machine according to claim 1, wherein the magnifying glass is used to enlarge the nail under the grinding wheel, so that the blood vessels of the pet nail can be observed more clearly, so that the direction and position of the nail can be adjusted reasonably.

6. The pet nail machine according to claim 1, wherein the filter box is used to store nail scraps generated during nail polishing and filter the odor generated during nail polishing.

7. The pet nail machine according to claim 1, wherein the filter is used to prevent nail scraps generated by the nail machine from being sucked into the inside of the nail machine shell, causing system failure; There is a filter cotton in front to absorb the smell generated by the nail.

8. The pet nail machine according to claim 1, characterized in that: the turbine is used to suck away the nail scraps and peculiar smell generated when the user polishes the nails of the pet, and store the nail scraps in the place. Mentioned in the filter box.

9. The pet nail machine according to claim 1, wherein the motor is used to drive the turbine and the grinding wheel to work when the pet nail machine is turned on.

10. The pet nail machine according to claim 1, wherein the battery is used to provide electrical energy to the motor and the main board.

11. The pet nail machine according to claim 1, wherein the control board is used to receive a user's control instruction, and perform corresponding functions according to the control instruction.

12. The pet nail machine according to claim 11, characterized in that: the user's control command is generated by the button, and the button can generate various control commands such as turning on, turning off, and switching gears, and the user Long press the button for 3 seconds to generate a power-on or power-off control command. In the power-on state, short press to switch one gear at a time. The gears are cycled from low, medium, and high modes to control the running speed of the grinding wheel.

13. The pet nail machine according to claim 12, characterized in that the control instruction is indicated by the running indicator light to indicate the current operating state of the system, and the running indicator light is distinguished by RGB three-color lights. The charging, low, middle, and high gears are indicated by different colors.

14. The pet nail machine according to claim 1, wherein the USB charging port is used to charge the battery and is electrically connected to the battery. When the operation instruction prompts that charging is required, Connecting the power supply to the USB charging interface, the charging of the pet nail machine can be completed.

15. A pet nail art machine according to claim 1, characterized in that: the housing is used to protect the internal circuit of the pet nail art machine and provide the buttons, the running indicator light and the USB charging interface External structure.
